(19) United States
(12) Patent Application Publication
(10) Pub. No.: US 2022/0058655 A1
(43) Pub. Date: Feb. 24, 2022

(54) AUTHENTICATION SYSTEM

(71) Applicant: Traitware, Inc., Nevada City, CA (US)

(72) Inventors: Herbert W. Spencer, Grass Valley, CA (US); Christopher M. Canfield, Santa Clarita, CA (US); Vince Conroy, Novato, CA (US)

(21) Appl. No.: 17/306,743

(22) Filed: May 3, 2021

Related U.S. Application Data
(63) Continuation of application No. 14/889,838, filed on Nov. 7, 2015, now abandoned.
(60) Provisional application No. 61/821,176, filed on May 8, 2013.

(51) Int. Cl. G06Q 20/40; H04L 9/32; H04L 9/08; G06F 21/73; G06F 21/44; G06Q 20/10; G06F 21/33; G06F 21/32; G06Q 20/32; G06Q 20/38

(52) U.S. Cl. CPC G06Q 20/40145; G06Q 2220/00; H04L 9/3247; H04L 9/3231; H04L 9/0869; G06F 21/73; G06F 21/44; G06Q 20/1085; G06F 21/335; G06F 21/32; G06Q 20/3223; G06Q 20/3823; G06Q 20/3829; H04L 2209/56; G06F 2221/2117; H04L 9/3226

(57) ABSTRACT

A user having a computer hardware device can perform a secure transaction by entering on the device user data comprising unique knowledge of the user (such as a password) or biometric information of the user or both, generating with the device processor a pseudo random number, and generating a seed for a public/private key pair by combining the user data and the pseudo random number. The key pair is generated with the seed and transmitted to the server. Also a digital signature is created with the private key and the user data and also transmitted to the digital signature. The digital signature is verified using the public key and if the user data matches previously stored user data, the transaction is allowed to proceed.

### CROSS-REFERENCE TO RELATED APPLICATION

This application claims the benefit of provisional application serial number Ser. No. 61/821,176 filed May 8, 2013. This Application is related to international publication number WO2013/138714 published Sep. 19, 2013.

### BACKGROUND

Identity fraud is the leading type of credit card fraud in the US. Over 9 million adults are victims each year, which results in $100 million in merchant losses. Despite the increased digital power available, the state of current security systems available for the prevention of identity fraud is still inadequate.

A problem associated with current security systems is that they lack the ability to truly discern an identity of an individual at the fundamental level.

Accordingly, there is a need for a better security system that is able to truly discern an identity of an individual in order to prevent identity fraud.

### SUMMARY

The present invention is directed to systems that satisfy this need. The systems permit improved security for transactions such as transactions on the internet, and in particular provide methods for authenticating a user for performing a transaction.

In particular a user utilizes a computer hardware device, the device comprising a processor and memory. As part of a registration process, the device is assigned a unique device identifier. The user enters on the device user data comprising unique knowledge of the user such as a password, or biometric information of the user such as a finger print, or both. The device processor generates a pseudo random number that is utilized with the user data to provide a seed that is used to generate a public/private key pair. The public key and the user data are transmitted to a server for storage to complete the registration process.

Once registration is complete the system is ready for a secure transaction. The hardware processor regenerates the same public/private key pair and uses the private key to generate a digital signature based on the public key and inputted user data. The digital signature is transmitted to the server. Also raw user data and the public key are transmitted to the server and optionally the unique device identifier. On the server side, the stored and received public keys are compared and if they match, the public key is used to verify the digital signature. The raw user data is also compared against previously stored user data, and if everything satisfactorily matches, the transaction is allowed to proceed. If the unique device identifier is transmitted it is optionally verified for security against a unique device identifier that has been stored by the server.

Accordingly a transaction can occur only if the user data is known to the person performing the transaction, and if the registered hardware device is used. If it is not the registered hardware device, and if the user data is not input into the registered hardware device, the correct private/public key pair will not be generated.

Optionally a device profile is generated and also transmitted to the server for further verification, where the transmitted device profile is compared against a previously stored device profile that was stored by the server. This add security

Preferably the user data is based on photoauthentication where the user selects a pictures from a plurality of pictures.

Optionally the user data is hashed and the hashed user data is used to generate the seed. Similarly hashed user data can be used throughout the process.

Optionally, as part of the registration process, the user can be authenticated to the server by the user (A) verifying personal information using a third party identity provider, government agency, any person with rights to validate the identity of the user (B) scanning a QR code presented to the user by the server, or (C) scanning a QR code presented to the user by a relying party on behalf of the server.

An advantage of the present invention is that the public and private keys are not stored on the memory of the hardware device, but rather are generated for every transaction, this adding security.

The same server can be used for a transaction as is used for registration and authentication, or a separate server can be used.

Other optional features are:

1. The hardware profile is hashed; and

2. Transactions only go forward only if comparison of the hardware profiles results in a difference less than a set tolerance.

The hardware profile can be based on user generated information on the hardware device and not information that is not so generated such as serial numbers or model type. This provides increased security.

In one version of the invention, the uniqueness of the device's hardware characteristics, based on individual's use of the device and the information that is created on the device by the user, can be determined on the basis of a comparison with multiple users' hardware characteristics and a probability determined as to the uniqueness of the device.

In one version of the invention a mobile touch screen device allows for the displaying of images associated with a user. The user chooses a sequence of images from a set of associated images. This sequence is then used to authenticate the user through the regeneration of a key representing the user's unique knowledge, regenerating a public/private key pair, and, optionally, regenerating a salt used for salting a hardware profile representative of the user. These credentials are used to authenticate the user through the server, which then allows a transaction to proceed if the user is authenticated. Optionally the server issues a “sessionId”, or “identity binding token” (IBT) allowing a user to access trusted resources. A relying party or a third party identity provider can control the server.

In one version the hash information and hardware profile are truncated to reduce the amount of information transmitted to a server. The truncation can be performed in such a way that sufficient information is retained to differentiate one hardware profile from another hardware profile.

Optionally, where the received hardware profile and the stored hardware profile are different by at least 0.02%, the transaction proceeds only if the received hardware profile and the stored hardware profile match by at least 60%.

The hashing of the hardware profile of the electronic communication device can be with user information stored on the device.

The invention also includes the hardware device comprising a processor, memory, and an input receiver for transmitting input to the processor, the device programmed to perform the method of claim 1 or claim 7.

### DRAWINGS

These and other features, aspects and advantages of the present invention will become better understood with regard to the following description, appended claims, and accompanying figures where:

FIG. 1 is a flow chart of an overall system having features of the present invention;

FIG. 2 shows a flow diagram that illustrates a process for registration of a device with a server; and

FIG. 3 shows a flow diagram that illustrates the process of authentication of a device with the server.

### DESCRIPTION

In the following description, specific details are given to provide a thorough understanding of the embodiments. However, it will be understood by one of ordinary skill in the art that the embodiments may be practiced without these specific details. Well-known circuits, structures and techniques may not be shown in detail in order not to obscure the embodiments. For example, circuits may be shown in block diagrams in order not to obscure the embodiments in unnecessary detail.

Also, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be rearranged. A process is terminated when its operations are completed. A process may correspond to a method, a function, a procedure, a subroutine, a subprogram, etc. When a process corresponds to a function, its termination corresponds to a return of the function to the calling function or the main function.

Moreover, storage in memory can be accomplished by one or more devices for storing data, including read-only memory (ROM), random access memory (RAM), magnetic disk storage mediums, optical storage mediums, flash memory devices and/or other machine readable mediums for storing information. The term “machine readable medium” includes, but is not limited to portable or fixed storage devices, optical storage devices, wireless channels and various other mediums capable of storing, containing or carrying instruction(s) and/or data.

Furthermore, embodiments can be implemented by hardware, software, firmware, middleware, microcode, or a combination thereof. When implemented in software, firmware, middleware or microcode, the program code or code segments to perform the necessary tasks can be stored in a machine-readable medium such as a storage medium or other storage(s). One or more than one processor can perform the necessary tasks in series, concurrently or in parallel. A code segment can represent a procedure, a function, a subprogram, a program, a routine, a subroutine, a module, a software package, a class, or a combination of instructions, data structures, or program statements. A code segment can be coupled to another code segment or a hardware circuit by passing and/or receiving information, data, arguments, parameters, or memory contents. Information, arguments, parameters, data, etc. may be passed, forwarded, or transmitted through a suitable means including memory sharing, message passing, token passing, network transmission, etc.

Methods and devices that implement the embodiments of the various features of the invention will now be described with reference to the drawings. The drawings and the associated descriptions are provided to illustrate embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” or “all embodiment” in various places in the specification are not necessarily all referring to the same embodiment.

Throughout the drawings, reference numbers are re-used to indicate correspondence between referenced elements. In addition, the first digit of each reference number indicates the figure where the element first appears.

In the following description, certain terminology is used to describe certain features of one or more embodiments of the invention.

“Transaction” means a communicative action or activity involving two parties or things that reciprocally affect or influence each other. A transaction can be ATM withdrawal or other financial transactions, accessing a file, logging into a website, opening a door to a business or house, starting a car, and being alerted to a washing machine reaching the end of its cycle.

“Hardware profile” means data that is generated by a user with regard to a hardware device and at least some data specifically associated with and created by the user. As examples, it can be information relating to installed applications, portions of the user's contacts, applications added by the user, music added by the user, and the like. It can be (a) contact information, (b) mobile network code, (c) information about music, (d) pixel colors from a background screen, (e) installed applications, (f) arrangement of installed applications, (g) frequency of use of applications, (h) location of the user, (i) Bluetooth device pairings, (j) carrier name, (k) mobile country code, (l) phone number, (m) photos, (n) device name, (o) MAC address, (p) device type, and combinations of one or more thereof.

The term “picture” means a painting, drawing, or photograph of someone or something, the terms “photo” and “photograph” mean a picture or likeness made with a camera, and additionally mean any graphical representation known in the art, such as a hologram, and any type of three-dimensional image.

The term “Traitware system” means a proprietary two factor authentication system wherein one factor may be a hardware profile of a user's device at least partly based on information on the hardware device resulting from action by the user (as compared to inherent information such as a serial number or model type) and the other factor is user information comprising information about the user, including biometric data.

The term “unique knowledge” means information unique or specific to a user such as answers to knowledge based questions, including photoauthentication. The term “photoauthentication” means a technique where a user demonstrates unique knowledge based on identifying one or more pictures from a plurality of pictures and/or manipulating one or more pictures such as swiping the picture in a selected manner.

The term “regenerated” in reference to the creation of a public/private key pair means that an identical public/private key pair may be recreated every time the process is invoked by using the user's unique knowledge.

The term “credential” refers to a set of data presented as evidence of a claimed digital identity. It can also refer to an object or data structure that authoritatively binds an identity to a token possessed and controlled by an individual (FICAM TFS).

The present invention uses a digital signature scheme. A digital signature scheme typically consists of three algorithms:

A) A key generation algorithm that outputs a private key and a corresponding public key.

B) A signing algorithm that, given information and a private key, produces a signature.

C) A signature verifying algorithm that, given the information, a public key corresponding to the private key, and a signature, either accepts or rejects the received information's claim to authenticity.

Two main properties are required. First, the authenticity of a signature generated from a fixed message and fixed private key can be verified by using the corresponding public key. Second, it should be computationally infeasible to generate a valid signature for a party without knowing that party's private key.

The term “digital signature” means data processed with the private key of a private/public key pair.

The term “digitally signed” is the process of using a private key to create a digital signature before information is sent from one device to another. A digitally signed hash value is generally included with the non-hashed information when sent. It is a common practice to verify the integrity of sent data and is known to those skilled in the art.

The term “token” refers to something that a claimant possesses and controls that is used to authenticate the claimant's digital identity. It can al so refer to something that an individual possesses and controls that is used to authenticate the individual.

The term “digital identity” refers to an attribute set that can be uniquely distinguished in a given context and can be used for a digital interaction.

The present invention requires two factor authentication by using (i) possession of a regenerated private key (something the user has) and (ii) user data comprising at least one of unique knowledge of a user (something the user knows) and a biometric characteristic of the user (something the user is) or both. If the unique knowledge and a biometric characteristic are used, there is three factor authentication. Optionally user information can be used, such as in the Traitware (trademark) authentication system, as described in PCT International Publication Number WO 2013/138714, which is incorporated herein by reference, so that up to four factor authentication is possible.

Two-factor authentication is an approach to strong authentication, which requires the presentation of two or more of the three authentication factors: a knowledge factor (“something the user knows”), a possession factor (“something the user has”), a biometric factor (“something the user is”). These factors are: 1) Something the user knows, unique knowledge of the user (e.g., password, PIN); 2) something the user has (e.g., ATM card, smart card, hardware token (RSA)); and/or 3) something the user is (e.g., biometric characteristic, such as a fingerprint).

A hardware profile optionally is used for what the user has. The hardware profile can include, but is not limited to information on the hardware device that typically can be affected by the user and selected from the group consisting of (a) contact information, (b) mobile network code, (c) information about music, (d) pixel colors from a background screen, (e) installed applications, (f) arrangement of the applications, (g) frequency of use of applications, (h) location of the user, (i) Bluetooth device pairings, (j) carrier name, (k) mobile country code, (l) phone number, (m) photos, (n) device name, and combinations of one or more thereof. The hardware profile can also include portions of any of the above such as just a portion of the titles of some of the music on the device 100. Contact information includes, but is not limited to, telephone numbers (home, work, and mobile), e-mail addresses (personal and work), addresses (home and work), and names (first, last, middle, and nickname) of contacts stored on a hardware device. Information about music includes, but is not limited to, song names, artist names, playlist names, songs in playlists, and duration of songs and playlists. Information about applications includes, but is not limited to, application names, size of applications, and version of applications. Information about photos includes, but is not limited to, photo names, photo locations, and photo sizes. In addition, and optionally, the hardware profile can include information not affected by the user such as the device serial number or product name.

User data can be unique knowledge of the user or a biometric characteristic of the user. The unique knowledge can be (i) a PIN, (ii) a password, (iii) user account number, (iv) at least one picture selected by the user from multiple pictures, (v) pictures selected by the user in a desired order, (vi) a swipe pattern on a picture, or (vii) multiple taps on a picture, and more than one of (i)-(vii). Where the unique knowledge involves pictures, it is referred to as photoauthentication. The unique knowledge can be a 3-dimensional password that may incorporate user gestures, a known location to be 3-dimensionally scanned, or any other known secret that may be adapted for use in the invention. Preferably the unique knowledge is at least one picture selected by the user.

The user information when used can comprise the user's (a) name, (b) social security number, (c) national identification number, (d) passport number, (e) IP address, (f) vehicle registration number, (g) vehicle license plate number, (h) driver's license number, (i) credit card information, (j) bank account information, (k) digital identity, (l) date of birth, (m) birthplace, (o) past and current residence, (p) age, (q) gender, (r) marital status, (s) race, (t) names of schools attended, (u) workplace, (v) salary, (w) job position, and combinations of one or more thereof.

The user's name can include, but is not limited to, first, last, middle, and any nicknames, and portions thereof. The user's social security number and IP address include all or part of the number and combinations thereof. The user's national identification number, passport number, vehicle registration number, vehicle license plate number, and driver's license number include letters and symbols, in addition to numbers, and portions thereof. Credit card information includes all or part of the number, expiration date, issuing bank, type (e.g. Visa, MasterCard, Discover, or American Express) and combinations thereof. The user's digital identity includes characteristics and data attributes, such as a username and password for various online accounts (e.g. banking, social media, weblogs, e-mail, etc), online search activities (e.g. electronic transactions), medical history, purchasing history, purchasing behavior. A digital identity can also be linked to an e-mail address, URL, and domain name.

The biometric characteristic can be fingerprint, retina, facial characteristic, and voice data of the user and combinations of one or more thereof. It can also be and EKG waveform and user DNA.

The present invention has the following features and advantages:

1. A stand-alone, easy-to-use secure log in for mobile and other devices that replaces passwords or PIN's;

2. A basic level of photoauthentication is 6 times greater than a standard PIN, and can be upgraded to 1/12.5 billion and even higher with features that are user-selected;

3. A versatile, single, integrated solution that does not require additional hardware;

4. When working with the Traitware system, the device is tightly bound to the individual and the actual use of the device is securely authorized for the registered user

5. A secure solution providing better security than other access technology;

6. A less cumbersome process of authentication for the user than other security systems;

7. The user can provide answers to knowledge-based questions that only the user can know all the answers to. The probability to which the user is identified can also be determined.

The use of photoauthentication and other types of unique knowledge allow a user to authenticate simply and securely by providing a known secret that is difficult to guess or spoof. Once a user has provided their unique knowledge this sequence may then in turn be used to authenticate the user through credential regeneration of a unique knowledge key, a public/private key pair, and, optionally, a random salt used for salting a device profile. These credentials are used to authenticate the user through an authentication server, which then allows a transaction to proceed if the user is authenticated. Optionally the authentication server can issue a sessionId, or Identity Binding Token (IBT) allowing a user to access trusted resources. A relying party or a third party identity provider can control the authentication server.

In general, once the user enters the correct user data into a hardware device that typically comprises memory, input means, a screen, and a processor, algorithms in installed software use the information from that sequence to generate a unique user data hash. The input means can be a keyboard, touch screen, memory card input slot, input connection for receiving data, and other devices known in the art for inputting data into computers and mobile devices such as smart phones. Preferably the user data is user knowledge, but it can be or also include biometric data. It is described below with regard to the preferred version of the invention, namely unique knowledge.

A hash of the unique knowledge can be used to create three distinct elements for authentication:

1. Unique Knowledge hash. A hash function is used to create a unique knowledge hash that can be checked against a previously stored knowledge has on an authentication server or other host server. If the unique knowledge is based on photoauthentication, this verifies that the correct photoauthentication sequence was entered on the user's device.

2. Device Profile Salt. The device profile can be salted using information contained in the unique knowledge hash. This verifies that the device profile came from a device whose unique knowledge hash was known to the individual authenticating. It prevents someone who attempts to spoof a unique knowledge hash authentication without having the device profile. Alternatively, the unique knowledge can be fed into an algorithm to generate a salt. Use of the device profile is optional, but preferred for increased security.

3. An authentication system key seed. This value is a combination of a value uniquely generated and stored on the device, typically a pseudo random generated number, and the unique knowledge provided by the user and it is used to seed the generation of a public/private key pair. The key pair is used to create a digital signature. Because the seed is a combination of a uniquely stored value and the user's unique knowledge, the seed can be recreated every time a user enters their unique knowledge into the device. Likewise, because the seed can be recreated, the public/private key pair can be regenerated using this recreated seed, thereby creating the same public/private key pair indefinitely. Since the key pair can be recreated, the key pair can be discarded after each use to prevent unauthorized use of the keys.

The unique knowledge hash is used to create all three elements, and without knowing the correct unique knowledge, the user's hardware device cannot be authenticated. Thus a transaction cannot go forward without the user's device and the unique knowledge of the user, providing a high level of security.

An advantage of this system lies in separation of elements used to authenticate. If a hacker hacks the app, the algorithms discovered that are used to generate the various elements are not enough to spoof authentication. The unique knowledge is used to generate the unique knowledge hash used to feed into those algorithms to get the outputs. Limits on authentication attempts in the event of a brute force attack can be created on the server. Likewise, in the event of a data breach on the authentication server database side, the information stored in a user account is not enough to allow for authentication, as the private key used to sign a payload is regenerated on the device for every authentication attempt using the unique knowledge. Separating the elements used for authentication and requiring the correct unique knowledge to be entered prevents nearly all of the most common authentication hacks.

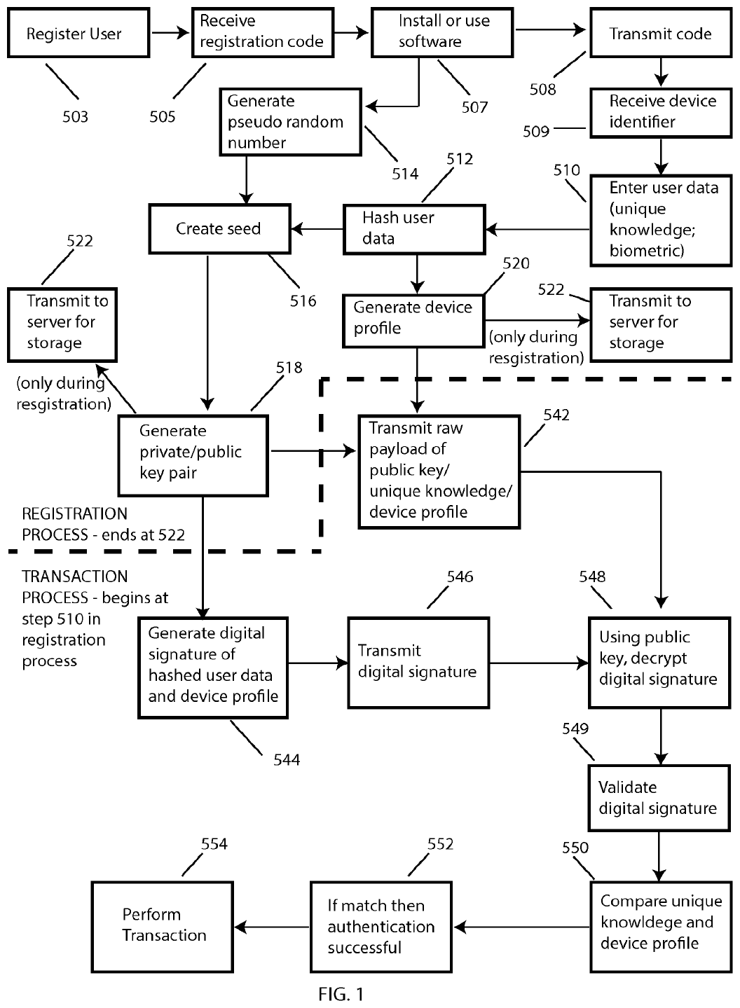

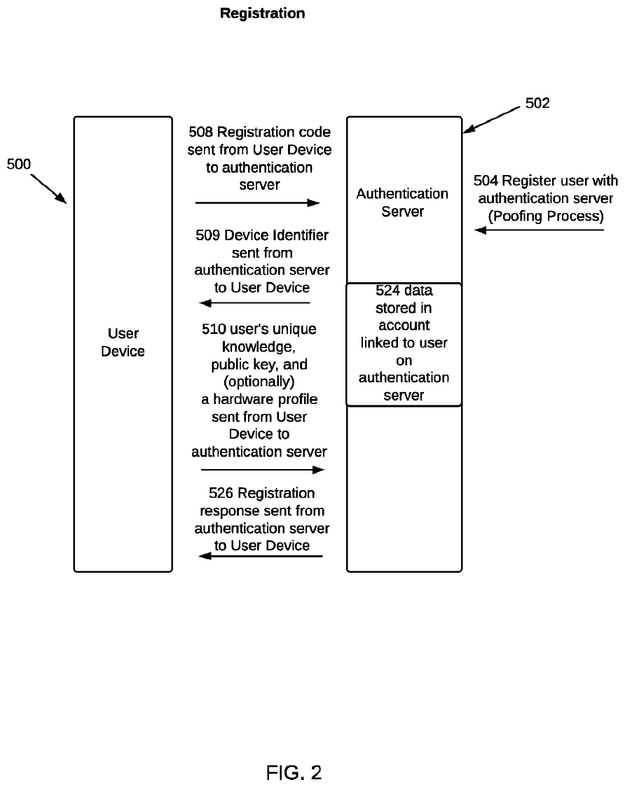

Referring now to FIGS. 1-3, a process having features of the present invention is depicted, where the system uses a hardware device 500, such as a smart phone or a computer, and an authentication server 502. Referring to FIGS. 1 and 2, the process of authenticating a user and the user's hardware device 500 the user wishes to authenticate with the authentication server 502 to allow for a transaction to proceed is schematically depicted. The upper portion of FIG. 1 above the dashed line is for the registration process and the lower portion below the dashed line in FIG. 1 is for the transaction process. As detailed below, some of the steps are used in both processes.

The user is first registered 503 with the authentication server 502, preferably after a proofing process and a user account is established. Data stored on the authentication server to represent this proofed identity can be personal information or something as simple as a unique identifier, which can allow for anonymity.

Upon successful registration of the user the device 500 is registered. This is effected by sending 505 a registration code from the server to the user. This can be transmitted via SMS, email through the internet, Bluetooth, or through other means. The user either installs 507 software on their device 500 or the device comes with embedded software allowing for communication with the authentication server 502. The user enters their registration code into the software on the device 500 and the code is transmitted 508 to the authentication server 502. Upon validating the registration code the authentication server creates a unique device identifier, associates it with the user account and stores it, and passes 509 the identifier to the device 500. The device 500 receives the unique device identifier and stores it for future use in device memory.

The user is then asked or prompted to enter user data such as unique knowledge or biometric information into the device 500 and the user does so 510. The unique knowledge can be a PIN, a password, a three dimensional password which includes user gestures, a photoauthentication sequence, knowledge of a particular biometric, or any other data representing unique knowledge of the user.

The software on the device uses this unique knowledge to create a public/private key pair and optionally a salt used in salting the hardware profile of the device. In particular, optionally the processor hashes the user data 512. From herein, where reference is used to using the user data, it can be raw user data or hashed user data. The processor generates 514 a pseudo random number using a conventional pseudo random number generator and this is combined with the user data, such as by concatenation, to create a seed 516 for generating 518 a private/public key pair. Optionally a device profile is generated 520. An identical key seed is created every time the process is invoked. The key seed is then used as a static value in creating a public/private key pair using known cryptographic key generators using the processor. Such key generators may be 2048-bit RSA or the various types of Elliptic Curve Digital Signature Algorithms (ECDSA). Depending on the particular key-generating algorithm used, additional parameters unique to each key-generating algorithm may need to be stored on the device 700. Key-generating algorithms generally rely on multiple parameters to generate keys, such as large prime numbers or an elliptic curve base point. Often the key-generating algorithm can generate these variables and it would be necessary to have access to them and store them indefinitely on the device. This is to allow for the generation of an identical public/private key pair each time the key pair is created. The only missing or needed component would be the user's unique knowledge, which is supplied prior to key generation. The remaining variables need to generate or regenerate the key would be retrieved from those on the device 500. Optionally, a biometric is used instead of a known secret (unique knowledge) to create the public/private key pair.

The device then sends 522 data representing the unique knowledge (one of the types of user data), the public key, and optionally the hardware profile to the authentication server 502. The device can optionally use a biometric in place or in addition to the unique knowledge. Likewise, information from the data representing the biometric can be used to construct the public/private key pair. The authentication server receives and stores 524 this data in the account associated with the user of the device 500. Preferably, a hash of the public key is stored. A registration response is returned 526 to the user indicating whether the registration was successful 514.

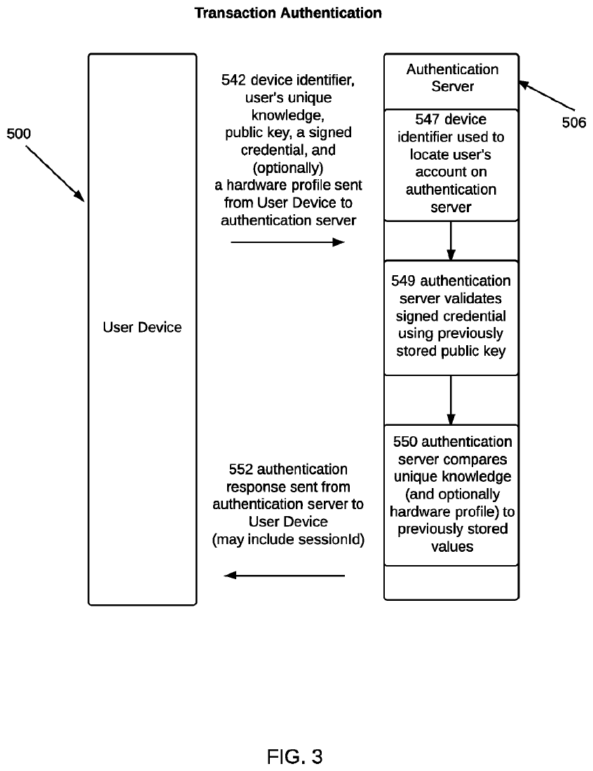

Referring to FIGS. 1 and 3, there is schematically shown the process of authenticating a registered user to allow for a transaction to proceed.

The user again enters their unique knowledge 510 into the device 500. This unique knowledge is again used to generate 518 a public/private key pair on the device utilizing the pseudo random number previously generated and stored and the created seed 516. Optionally, the hardware profile of the device 5 is gathered again 520. A package containing the user data and the public key, the unique device identifier, and optionally the device profile in raw form is transmitted 542 to the server 502. Also the previously stored unique device identifier, the public key, and the user data encrypted with the private key as a digital signature (preferably hashed user data) is generated 544 and transmitted 546 to the server. The digital signature, also referred to as a signed credential, is preferably a hashed concatenation of this data sent to the authentication server, which is signed with the private key generated from the user's unique knowledge. Optionally, a hardware profile is also sent to the authentication server and is included in the signed credential. The hardware profile can be salted using an algorithmic transformation of the user's unique knowledge to create the salt.

The authentication server receives the data from the device and locates the user account associated with the received device identifier. The authentication server 502 locates 547 the user's account using the device identifier. The server 502 then verifies that the received public key matches the public key received during the registration process. If the public key is stored in hashed form on the authentication server then the received public key is hashed prior to comparison. Then, if the public key received is validated, it is used to decrypt 548 the signed credential received from the device, giving the authentication server access to the unsigned hash that was digitally signed on the device. The authentication server concatenates and hashes the raw data received from the device in the same order is was concatenated, hashed, and signed with the private key on the device prior to being sent to the authentication server. A direct comparison 549 is made between the hash constructed on the authentication server and the hash signed by the private key, which has now been unencrypted with the public key. If the hashes match the integrity of the received data, the received data is valid. The authentication server then compares 550 the raw received unique knowledge with that previously stored on the authentication server 502. If there is a match, the user has been authenticated 552. Optionally a biometric may be used in place or in addition to the user's unique knowledge. Optionally a hardware profile can be used in comparison 550, where the hardware profile is included in the data sent to the authentication server, both in raw form and included in the digitally signed credential or signature. The hardware profile sent from the device must match the previously stored hardware profile on the authentication server within a set tolerance to allow for the transaction to proceed.

An authentication response 552 is passed back to the device indicating whether or not the transaction is allowed to proceed. The authentication server can then use the authentication status of that user in allowing transactions to proceed on the same server or a separate server (not shown) such as a resource center or transaction server. Herein “transaction” is used broadly to refer to any on-line (includes wireless) activity that requires security (such as access by a password) is performed, including making purchases, tweeting, obtaining information, updating information, voting on American Idol, and accessing a Facebook page or other web site. For example, a resource server may query the authentication server as to the status of authentication for a particular user or the authentication process can be invoked in the middle of a transaction between a user and a resource server. Optionally a sessionId may also be returned to the hardware device. A sessionId is a time-limited token that may be used in future transactions by being submitted to the authentication server. Using a sessionId allows the user to conduct 554 multiple transactions without having to be authenticated for each individual transaction.

In another version of the invention at least one of the user information and the hardware profile are salted and hashed prior to linking to create a combined electronic identification. Alternatively, both the user information and the hardware profile are salted and hashed prior to linking.

In one version of the invention, the unique knowledge, including photoauthentication data, and/or the hardware profile, can be salted and/or hashed before transmission to the server. Optionally there can be multiple authentication servers 502.

The hardware device 500 is preferably any device configured with a touchscreen that has the ability to engage in secure wireless communications with various communication networks, such as cellular, satellite and the various forms of Internet connectivity. In one embodiment, the hardware device 500 is capable of capturing biometric input including, but not limited to, fingerprint, facial recognition, voice verification, and vein verification. The hardware device 500 typically comprises a processor, memory, an input interface (also referred to as an input receiver), and a transmitter, the processor being programmed to process through the input interface user information, data representing unique knowledge of the user and/or biometric characteristics of the user, and a hardware profile of the device, and transmit through the transmitter what is processed to the server 502. The input receiver can be a touchscreen, keyboard, input jack, memory card slot, wireless receiver, and any other input device useful for computers and smart phones known to the art. The device 500 can include an interface for receiving biometric characteristics such as a fingerprint scanner. In one version of the invention, the hardware device 100 is a mobile phone, computer, or tablet computer. The input interface is preferably a touchscreen interface, and the transmitter is preferably a wireless communication module. Preferably there is a single authentication server 502 for authenticating the device 100 and the user, but there can be more than one server.

The server compares for authentication purposes what is stored in its memory and what is received from the device 500 to authenticate the user and the device 500. If both are authenticated, a transaction is allowed to proceed.

The server 502 can be a conventional server that comprises a processor, memory, an input interface, and a connection for receiving information executable by the processor. The memory stores (i) data representing unique knowledge of the user and/or one or more than one biometric characteristic of the user and (ii) the public key and (iii) the unique device identifier and (iv) optionally a hardware profile of the device 500, and (v) optionally user information. The processor is programmed to receive through the connection output from the device 100, store in memory the received output, compare the received output against what is stored in memory, and allow a transaction to proceed only if both the device 500 and the user are authenticated.

Optionally a different device than the authenticated device 500 can be used for a transaction. For example, once the device 500 such as a smart phone, and the user are authenticated, the system can allow the user to use a different device associated with the user such as a desktop computer. This can be accomplished by the server 502 sending a code to the device 500 which can be used on the desktop computer for signing in.

Preferably the authentication server 500 is an infrastructure as a service (IaaS) provider that includes at least two 64-bit high-CPU medium Amazon Elastic Compute Cloud (EC2) server instances to be used for active Mongo database hosts, which are connected to a load balancer, which is in turn connected to the client. Preferably, the authentication server 500 also includes 16 Elastic Block Store (EBS) volumes to be used in two redundant arrays of independent disks (RAID) 10 arrays to support active Mongo database servers, and one 64-bit micro instance to be used for Mongo Arbiter role.

When the server 502 is referred to herein, such a server can comprise multiple linked servers, such as by using one linked server for part of the registration and authentication processes and using a different linked server for other portions of the registration and authentication processes. Also, for registering the user, a separate evaluation server can be used such as one associated with a third party authentication authority such as a credit information agency, such as, but not limited to, Experian.

Optionally the aforementioned Traitware security system, where a combined electronic identification associated with the hardware device 500 and user information is created can be used for additional security.

It is not necessary that when a comparison is run, there be complete 100% identity between stored information and received information. For example, differences in a stored hardware profile and a received hardware profile may occur as a user adds or deletes programs and information to the hardware device 500. Accordingly tolerances for differences can be built into the system. For example, for lower value transactions the probability that it is an authenticated user and/or authenticated device can be set at 80%. For higher value transactions the probability can be set at 99.999999%.

In one version of the invention, if the confidence score is not within the accepted tolerances, further authentication can be required. The server 502 can transmit one or more knowledge based questions (KBQ) to the hardware device. The knowledge questions are commonly used by credit agencies to verify a user's identity, and are commonly known in the art, e.g., “What was the color of your first car?” Preferably, the knowledge questions are sent in extensible markup language (XML) format. The user is presented 234 with the knowledge questions, the user provides answers to the knowledge questions, and the answers are sent back to the server.

When the system utilizes salting, preferably salting is done by a three to seven digit random number generator. When the system utilized hashing, preferably hashing is done by Secure Hash Algorithm-2 (SHA-2). The hash can be four digits of a 64 bit string. Preferably, salting and hashing occur before transfer to any external device by the device 500. The salting and hashing can be by individual items or in groups of items. In one version the hash is truncated to reduce the amount of information transmitted to the server 502. The truncation can be performed in such a way that sufficient information is retained to differentiate one user from another user.

In one version of the invention, once the combined electronic identification is created, no personal identifying factors are retained or only a selected set is retained on the hardware device, such as the user's name and address.

If user information is used, the above-described method is accomplished by executing the following algorithm:

I. User Information
1) Concatenate provided e-mail (SHA-2) and MAC address (SHA-2) and store. Include the salt: (SHA-2/123e-mailAddressSHA-2/321MACaddress). Salt is the extra digits appended to e-mail and MAC (123,321).

II. Generate Confidence Score
1) User Activity
   a) Did user perform an activity that enhances the confidence that they are the actual user of the device, such as selecting information already stored on the hardware device or whether the user is at a normal location consistent with their activities?
      i) If yes, set variable DPID to 90%
      ii) If no, set variable DPID to 70%
2) Receive KBQ identity score from evaluation server.
   a) If KBQ identity score is over 66, allow creation of combined electronic identification.
   b) If KBQ identity score is below 66, deny creation of combined electronic identification.
3) Calculate confidence score. Confidence score is stored on authentication server, never passed to hardware device.
   a) Confidence Score=(PID from Experian*DPID)*(0.01*KBQ identity score)
   b) Example: (630*0.9)*(0.01*73)=413, where for purposes of this example 630 is a generic PID that is representative of the type of score that can be provided.

III. Hardware Profile
1) Initial and Subsequent State Characteristics
   a) Device Characteristics
      i) Device name (*name)
      ii) Carrier name (*carrierName)
      iii) Mobile Country Code (*mcc)
      iv) Mobile Network Code (*mnc)
   b) Device Personality
      i) Contacts using full name.
      ii) Songs using full song names.
      iii) Application names.
      iv) Bluetooth device parings. (go over testing methods with Charles)
      v) Photo names (as stored on device)
      vi) Photo locations
2) Traitware systemID (TWID-Initial State)—Items sent to MongoDB

With the following items, create salted hashes with dynamic salt on the device and send to the server. In addition, store the salt independently on the device. Use a random five digit number for the salt.
a) Initial Database of Contacts (Full Name)
b) Initial Database of Song Titles (Use full titles)
c) Initial Database of Apps (App name)
d) Bluetooth Device Pairings
e) Device name (*name)
f) Carrier name (*carrierName)
g) Mobile Country Code (*mcc)
h) Mobile Network Code (*mnc)

In one embodiment, the set tolerance for the hardware profile is between 0.02% and 76%. If the current hardware profile matches the previously stored hardware profile within the set tolerance, the transaction is allowed to proceed. Preferably the transaction is allowed to proceed only if the current hardware profile and the previously stored hardware profile are different by at least a factor which is a function of the time since the last transaction. For example, a transaction may not be allowed to proceed unless there is a 0.02% change in the hardware profile, which can represent a change in one of the user's characteristics after a week.

In one version of the invention, the transaction is not allowed to proceed if the received hardware profile and the stored hardware profile are identical, which can indicate a copied profile.

A new confidence score can be generated by using the previously stored sent data and the currently received sent data, the confidence score calculated based on the percent differences, and the previously calculated confidence score. The new confidence score is a numerical representation between 0 and 1 of the probability that the user is a fraud.

In one version of the invention, the percent differences between user hardware profiles are computed using the Levenshtein Distance equation, which defines the distance between two strings is given by where:

The new confidence score is checked to determine if it is within a set tolerance. Preferably, the set tolerance is 99.999999%, so that the transaction proceeds only if the new confidence score is over 99.999999%. If it is not, then additional steps are taken to increase the new confidence score, such as prompting the user for a password or biometric authentication. If the confidence score is unable to be increased, the transaction is not allowed to proceed.

If the new confidence score is within the set tolerance, the new stored sent data replaces the previously stored data on the server and the transaction is allowed to be completed.

In another version of the invention, the transaction is allowed to proceed only if the received hardware profile and the stored hardware profile match by at least 40%. Alternatively, the transaction is allowed to proceed only if the received hardware profile and the stored hardware profile match by at least 50%. In another version the transaction is allowed to proceed only if the received hardware profile and the stored hardware profile are different by at least 1%.

Although the present invention has been discussed in considerable detail with reference to certain preferred embodiments, other embodiments are possible. Therefore, the scope of the appended claims should not be limited to the description of preferred embodiments contained in this disclosure.

All the features disclosed in this specification (including any accompanying claims, abstract, and drawings) can be replaced by alternative features serving the same, equivalent or similar purpose, unless each feature disclosed is one example only of a generic series of equivalent or similar features.

1-22. (canceled)

23. A method for a user having a computer hardware device, the computer hardware device comprising a processor and memory, to perform secure transactions using the computer hardware device, the method comprising the steps of:
a. registering the user with an authentication server after a proofing process;
b. establishing a user account on an authentication server and creating a registration code associated with the user account;
c. generating on the computer hardware device with the processor a public/private key pair;
d. storing the public/private key pair on the computer hardware device;
e. generating on the computer hardware device a device profile;
f. obtaining the registration code on the hardware device;
g. registering the computer hardware device to the user before performing the transactions, the registration comprising the steps of:
i. transmitting the registration code from the hardware device to the authentication server, the registration code associated with the user account, and
ii. transferring a hash of the device profile to the authentication server and storing and associating the device profile with the user account; and
h. after the computer hardware device is registered to the user, using the computer hardware device and the user account for authentication before permitting a transaction to proceed.

24. The method of claim 23, wherein the proofing process comprises receiving a biometric.

25. The method of claim 24, wherein the biometric is entered on the computer hardware device and is compared to a previously stored biometric stored on an external server, and the registering a user proceeds if biometric and the previously stored biometric match within a set tolerance.

26. The method of claim 23, wherein the proofing process comprises a personal information of the user.

27. The method of claim 26, wherein the personal information is entered on the computer hardware device, and the method further comprises receiving a third-party identity provider information, and the registering a user proceeds if the personal information and the third-party identity provider information matches within a set tolerance.

28. The method of claim 23, wherein the proofing process comprises receiving a biometric and receiving personal information of the user.

29. The method of claim 28, wherein the device profile comprises information on the hardware device selected from the group comprising (a) contact information, (b) mobile network code, (c) information about music, (d) pixel colors from a background screen, (e) installed applications, (f) arrangement of installed applications, (g) frequency of use of applications, (h) location of the user, (i) Bluetooth device pairings, (j) carrier name, (k) mobile country code, (l) phone number, (m) photos, (n) device name, (0) MAC address, or combinations of one or more thereof.

30. A method for a user having a computer hardware device, the computer hardware device comprising a processor and memory, to perform secure transactions using the computer hardware device, the method comprising the steps of:
a. registering the user with the authentication server after a proofing process;
b. establishing a user account on an authentication server and creating a registration code associated with the user account;
c. generating on the computer hardware device with the processor a public/private key pair and storing the key pair on the computer hardware device;
d. generating on the computer hardware device a device profile;
e. obtaining the registration code on the computer hardware device;
f. registering the computer hardware device before performing the transaction, the registration comprising the steps of:
i. transmitting the registration code from the computer hardware device to the authentication server, the registration code associated with the user,
ii. transferring a hash of the device profile to the authentication server and storing and associating the device profile with the user account;
g. using a registered computer hardware device and user account for authentication for a transaction using the steps of:
i. inputting to the computer hardware device user data comprising unique knowledge, biometric information of the user, or both the unique knowledge and biometric information of the user;
ii. transmitting to a server a package comprising (1) the user data, (2) the public key,
iii. creating a digital signature with the private key, the user data, and the device profile,
iv. transmitting the digital signature to the authentication server,
v. receiving from the authentication server permission to proceed with the transaction if the digital signature is verified and the user data and the device profile of the package match a previous user data and a previous device profile previously sent to the authentication server, and
vi. performing a secure transaction.

31. The method of claim 30, wherein the device profile comprises information on the hardware device selected from the group comprising (a) contact information, (b) mobile network code, (c) information about music, (d) pixel colors from a background screen, (e) installed applications, (f) arrangement of installed applications, (g) frequency of use of applications, (h) location of the user, (i) Bluetooth device pairings, (j) carrier name, (k) mobile country code, (l) phone number, (m) photos, (n) device name, (0) MAC address, or combinations of one or more thereof.

32. The method of claim 30, wherein the proofing process comprises receiving a biometric.

33. The method of claim 32, wherein the biometric is entered on the computer hardware device and is compared to a previously stored biometric stored on an external server, and the registering a user proceeds if biometric and the previously stored biometric match within a set tolerance.

34. The method of claim 30, wherein the proofing process comprises a personal information of the user.

35. The method of claim 34, wherein the personal information is entered on the computer hardware device, and the method further comprises receiving a third-party identity provider information, and the registering a user proceeds if the personal information and the third-party identity provider information matches within a set tolerance.

36. The method of claim 30, wherein the proofing process comprises receiving a biometric and receiving personal information of the user.
